(19) United States
(12) Patent Application Publication
(10) Pub. No.: US 2010/0006305 A1
(43) Pub. Date: Jan. 14, 2010

(54) FRAME AND HOSE MONITOR RISER

(75) Inventor: Todd Brian Lozier, Elkhart, IN (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: Elkhart Brass Manufacturing Company, Inc., Elkhart, IN (US)

(21) Appl. No.: 12/501,138

(22) Filed: Jul. 10, 2009

Related U.S. Application Data
(60) Provisional application No. 61/079,755, filed on Jul. 10, 2008.

(51) Int. Cl. A62C 27/00

(52) U.S. Cl. 169/24

(57) ABSTRACT

A fire fighting device for a fire truck includes a frame, which is adapted for mounting to the deck of a fire truck and has a mounting surface for mounting a fluid monitor to the frame. A flexible fluid conduit extends through the frame, which is in fluid communication with a supply of fluid and provides fluid communication with a fluid monitor mounted to the mounting surface for delivering fluid to the fluid monitor.

This application claims the benefit of provisional application entitled FRAME AND HOSE MONITOR RISER, U.S. Application Ser. No. 61/079,755 filed on Jul. 10, 2008, which is herein incorporated by reference in its entirety.

### TECHNICAL FIELD AND BACKGROUND OF THE INVENTION

The present invention relates to fire fighting equipment and, more particularly, to a support for a fire fighting monitor.

Fire fighting monitors may comprise portable monitors or fixed monitors. Fixed monitors are typically mounted to the deck of the fire truck and may be mounted to an adjustable support so that the monitor can be raised or lowered relative to the deck of the truck. The raised position typically corresponds to an operating position where the monitor can operate in service at a location above other truck features or truck mounted devices (e.g. the cab of the truck, light bars, ladder storage racks, etc). The lowered position typically corresponds to a storage or stowed position. In the stowed position, the monitor ideally does not increase the overall height of the truck, which often has limited clearance to enter/exit the firehouse.

Traditional adjustable supports all solve the problem of providing monitor elevation using a linear mechanism and a solid waterway that can be lengthened or shortened while still providing a means to deliver water in a closed waterway. Further, the waterway either provides the supporting structure or is a part of the supporting structure. However, this linear extension and the contribution by the waterway to the structural support may prove limiting in some applications.

Accordingly, there is a need for a fire fighting monitor support that will allow the monitor to be raised and lowered while providing a greater range of motion and flexibility and which can reduce the friction loss associated with conventional waterways.

### SUMMARY OF THE INVENTION

Accordingly, the present invention provides a fire fighting monitor support that allows a monitor mounted on the support to be raised and lowered with a greater range of motion for the monitor mounted to the support and further that decouples the waterway from the supporting function of the support.

In one form of the invention, a fire fighting device for a fire truck includes a frame and a flexible fluid conduit extending through the frame for coupling to a fire fighting monitor mounted to the frame. The frame is adapted for mounting to the deck of a fire truck and includes a mounting surface for mounting the fluid monitor to the frame.

In one aspect, the mounting surface is movably supported relative to the deck wherein a fluid monitor mounted to the mounting surface can be moved vertically, laterally, and/or longitudinally with respect to the longitudinal axis of the fire truck.

In one aspect, the flexible fluid conduit comprises a hose.

In another aspect the frame is collapsible.

According to yet another aspect, the frame may be mounted to the deck by a guide track, with the frame including a plurality of guides for engaging the guide track. Further, the frame may be mounted using two guide tracks. Alternately or in addition, the frame may be mounted to the deck by a plurality of pivot connections.

In addition, the fire fighting device may be provided with an actuator, which moves the mounting surface relative to the frame connection. For example, suitable actuators may include hydraulic, electric, pneumatic or manual actuators, including linear actuators, such as cylinders.

In another form of the invention, a fire fighting device for a fire truck includes a collapsible frame and a fluid conduit extending through the frame.

In one aspect, the fluid conduit comprises a flexible fluid conduit. For example, the flexible fluid conduit may comprise a hose.

According to yet other aspects, the fire fighting device is provided in combination with the fire truck. The fire truck has a deck with the frame mounted to the deck.

In still further aspects, the collapsible frame may comprise a box-shaped frame with a plurality of column frame members, with each of the frame members having a frame connection for mounting to the deck of the fire truck.

In addition, the fire fighting device may be provided with an actuator, which moves the mounting surface relative to the frame connection. For example, suitable actuators may include hydraulic, electric, pneumatic or manual actuators, including linear actuators, such as cylinders.

In another form of the invention, a fire truck includes a deck, a mounting surface for lateral movement relative to the deck, and a collapsible frame supporting the mounting surface on the deck. A fluid monitor is mounted to the mounting surface, and a flexible conduit is provided that extends between the frame and the monitor, which is in fluid communication with the fluid monitor and a supply of fluid for delivering fluid to the fluid monitor.

In one aspect, the flexible conduit comprises a hose.

Accordingly, the present invention provides a fire fighting device that allows a monitor to be raised and lowered relative to a fire truck deck but also provides a greater range of motion for the fire fighting monitor, while still providing a compact stowed configuration that may be configured to not increase the overall height of the truck. Further, by providing a flexible conduit without a plurality of elbows and bends, the friction losses in the waterway provided by the flexible conduit can be reduced over conventional waterways.

These and other objects, advantages, purposes, and features of the invention will become more apparent from the study of the following description taken in conjunction with the drawings.

### DESCRIPTION OF THE FIGURES

FIG. 1 is a side elevation view of a fire fighting monitor support illustrated mounted to a deck of a fire truck;

FIG. 2 is a similar view to FIG. 1 of the support shown with the monitor removed illustrating the mounting surface for the monitor lowered in position relative to the deck;

FIG. 2A, 2B, and 2D are plan views of several embodiments of the monitor mounting surface;

FIG. 2C is a side elevation view of the frame and mounting surface of FIG. 2B;

FIG. 2E is a side elevation view of the frame and mounting surface of FIG. 2D;

FIG. 3 is a side elevation view of another embodiment of the support of the present invention; and

FIG. 4 is a side elevation view of a third embodiment of the support of the present invention.

### DETAILED DESCRIPTION OF THE PREFERRED EMBODIMENTS

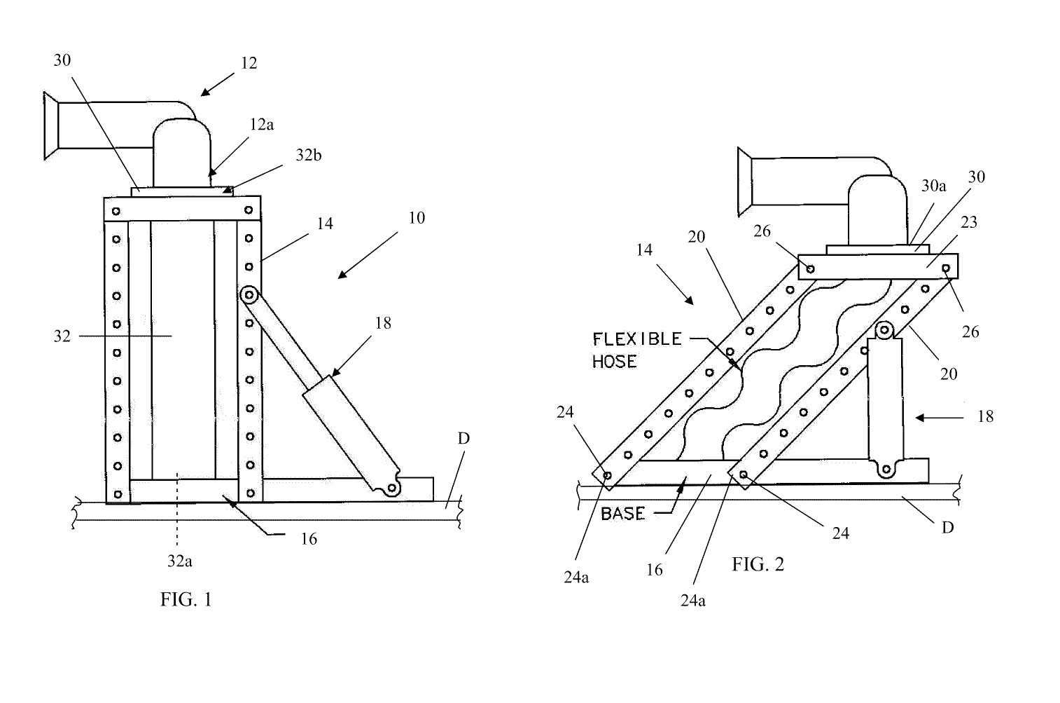

Referring to FIG. 1, the numeral 10 generally designates a fire fighting monitor support for raising or lowering a monitor 12 mounted to the support relative to a deck D of a fire truck. As will be more fully described below, support 10 may provide a greater range of motion for the monitor 12 relative to the deck of the fire truck and, further, provide greater flexibility so that it can be adapted to many different apparatus applications. In addition, by incorporating a flexible conduit (32), the friction losses in the fluid delivered to the monitor may be reduced.

Referring again to FIG. 1, support 10 includes a frame 14 and a base 16, which provides a connection for frame 14 to deck D. In the illustrated embodiment, base 16 provides a pivotal connection for frame 14 relative to deck D and, further, provides a mounting surface for an actuator 18 for raising or lowering frame 14 and, hence, monitor 12 relative to deck D. For examples of suitable monitors, reference is made to U.S. Pat. Nos. 7,191,964; 7,243,864; 6,994,282, and 6,786,426, which are all commonly owned by ELKHART BRASS MANUFACTURING of Elkhart, Indiana and are incorporated in their entireties by reference herein.

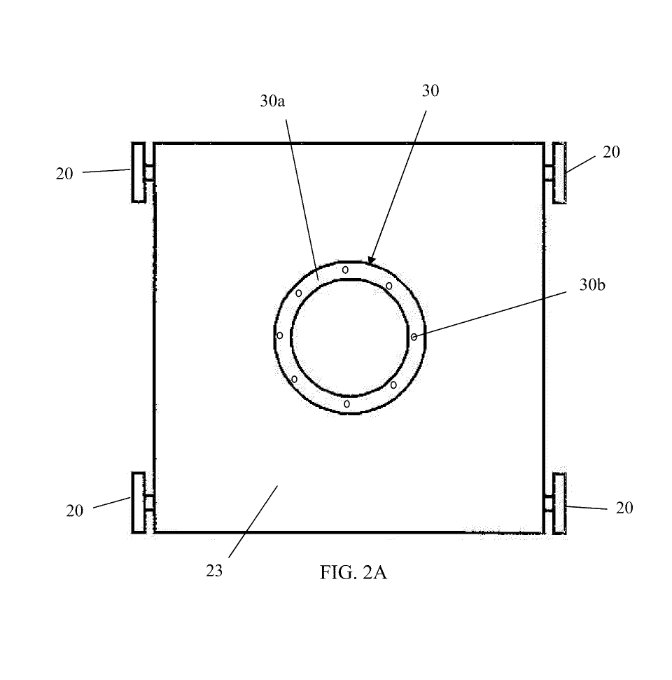

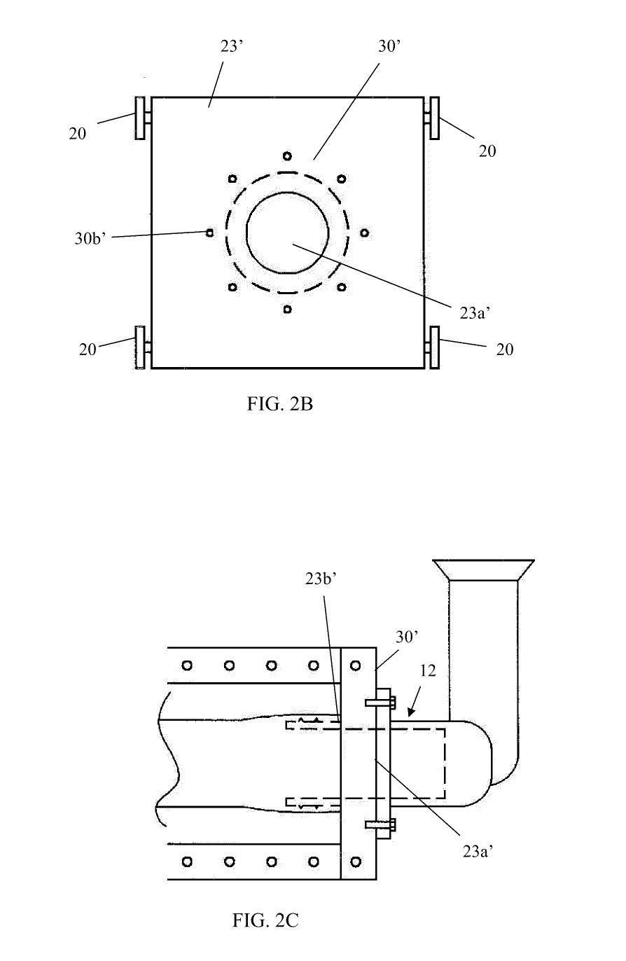

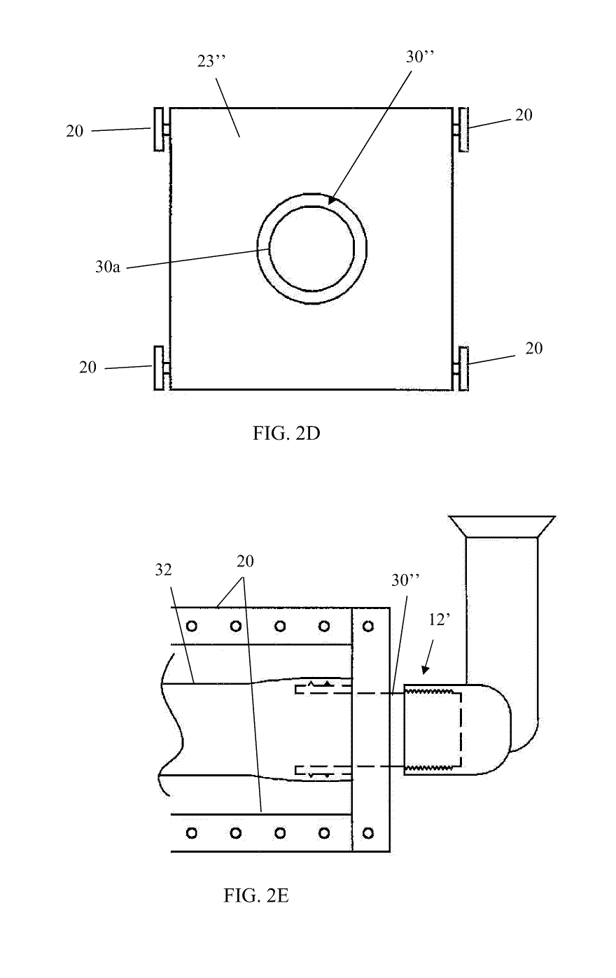

Referring to FIG. 2, frame 14 includes a plurality of column frame members 20 (typically four) and a transverse plate 23, which are interconnected to form a box-shaped collapsible frame that surrounds the flexible conduit 32.

The proximal ends of frame members 20 are pivotally mounted to base 16 at pivot connections 24 formed, for example by pins, and, further, are pivotally mounted at their distal ends to a transverse plate 23, similarly by pins 26. As noted together the column frame members 20 and transverse plate form the box-shaped frame. Frame members 20 may be formed from tubular members or structural angle members or the like and may be formed from a variety of materials, including metal, a polymer, such as a reinforced polymer, or a combination of both. Further, to increase the adjustability of the frame, frame member 20 may include a plurality of mounting points, for example, mounting openings, for connecting the actuator to the frame, for example.

Mounted to transverse plate 23 is a mounting flange 30, which provides a mounting surface 30a for monitor 12. As best understood from FIG. 2, when frame 14 is pivoted relative to base 16 and deck D and frame 14 collapses like in a four bar linkage, mounting surface 30a of mounting flange 30 can translate relative to the connections 24 that mount frame 14 to deck D via base 16. So in addition to vertically lowering or raising the monitor, frame 14 allows the monitor to be moved laterally. Typically, support 10 is mounted to a fire truck so that the pivot axes 24a of pivot connections 24 are generally orthogonal to the longitudinal axis of the truck so that when frame 14 pivots around pivot axis 24, frame 14 will collapse about axes that are generally perpendicular or orthogonal to the longitudinal axis of the truck and, further, so that mounting surface 30a translates longitudinally relative to the longitudinal axis of the truck. It should be understood that support 10 may be rotated so that the relative translation of mounting surface 30a may be transverse to the longitudinal axis of the truck, or may be skewed.

As best understood from FIGS. 2 and 2A, flange 30 may be supported on plate 23 by a pipe section or lip 31, which is mounted to or cast with plate 23. For example, transverse plate 23, pipe section 31, and flange 30 may be a monolithic member that is assembled by welding the individual components together, which is then fastened or welded to transverse members 22, or may be cast a single component. Further as best seen in FIG. 2A, flange 30 includes a plurality of mounting openings or taps 30b to which flange 12a of monitor 12 is bolted. Pipe section 31 is then in fluid communication with flexible conduit 32 and further may extend through plate 23 to form a coupler for coupling to flexible conduit 32. For example, pipe section 31 may have grooves to allow conduit 32 to be clamped onto and thereby be secured to pipe section 31.

Alternately, frame 14 may have a mounting surface 30′ provided on upper surface of plate 23′. Mounting surface 30′ extends around an opening 23a′ formed in plate 23′, which is in fluid communication with a lip or pipe section 23b′ that is formed, such as by casting, or mounted, such as by welding, to the underside or back of plate 23′ (FIG. 2C). Optionally, opening 23a′ may be threaded to receive pipe section 23b′. Pipe section 23b′ is then in fluid communication with flexible conduit 32 and may form a coupler for coupling to flexible conduit 32. For example, pipe section 23b′ may include groves on which the flexible coupler may then be clamped to couple the flexible conduit to pipe section 23b′. In this manner, the mounting flange 12a of monitor 12 may be directly mounted and bolted to plate 23′ over opening 23a′ via mounting openings or taps 30b′ to fluidically couple monitor 12 to flexible conduit 32.

In another embodiment, the mounting surface is provided by a pipe section 30″. Pipe section 30″ may be mounted to or formed with plate 23″. In this embodiment, pipe section 30″ may form the base of an NPT monitor and therefore have grooves for receiving the ball bearings of the monitor to thereby rotatable mount the monitor body to pipe section 30″. Referring to FIGS. 2D and 2E, pipe section 30″ extends through plate 23″to connect to and be in fluidic communication with monitor 12′ on one side and in fluidic communication with flexible conduit 32 on its other end and further may provide a coupler for flexible conduit 32.

It should be understood that the plate of the frame may have monitor or flexible conduit mounting structures that are either mounted to the plate or may be formed as part of the plate. As noted, the base of the monitor itself may be formed as part of or mounted to the plate. Further, while plates described above are illustrated to be solid, they could be foraminous or perforate (i.e. have a plurality of openings). Additional, the plates may be mount to the ends of columns 20 by intermediate members. Further, instead of a plate, a box member or a frame formed form a plurality of transverse members may be used.

As noted above, frame 14 is pivoted about axes 24a by actuator 18. Actuator 18 may comprise an electric, hydraulic, or pneumatic actuator, including a linear actuator, such as a cylinder, which is mounted at one end to base 16 and at its opposed end to frame 14 so that when actuator 18 contracts frame 14 will fold and collapse about axes 24a and when extended will extend frame 14 to its upright, extended position, or beyond depending on the stroke of the actuator. Further, it should be understood that the actuator may be a manual actuator. Therefore, it should be understood that the method of moving the frame may be varied and suited to a specific application and needs of the user.

Referring again to FIG. 1, extending through frame 14 as flexible conduit 32, which is in fluid communication with a fluid supply, for example a fluid supply onboard the truck, such as a truck tank, or an external fluid supply. Further, flexible conduit 32 is in fluid communication with the inlet of monitor 12 so that flexible conduit 32 delivers fluid to monitor 12 when connected with the fluid supply. In the illustrated embodiment, conduit 32 comprises a flexible hose, which includes a connector 32a for coupling to the stanchion, for example a conventional stanchion on a fire truck, which provides fluid connection to the truck tank. Similarly, the opposed end of conduit 32 may include a similar coupler 32b for coupling to the inlet of monitor 12 as will be understood by those skilled in the art.

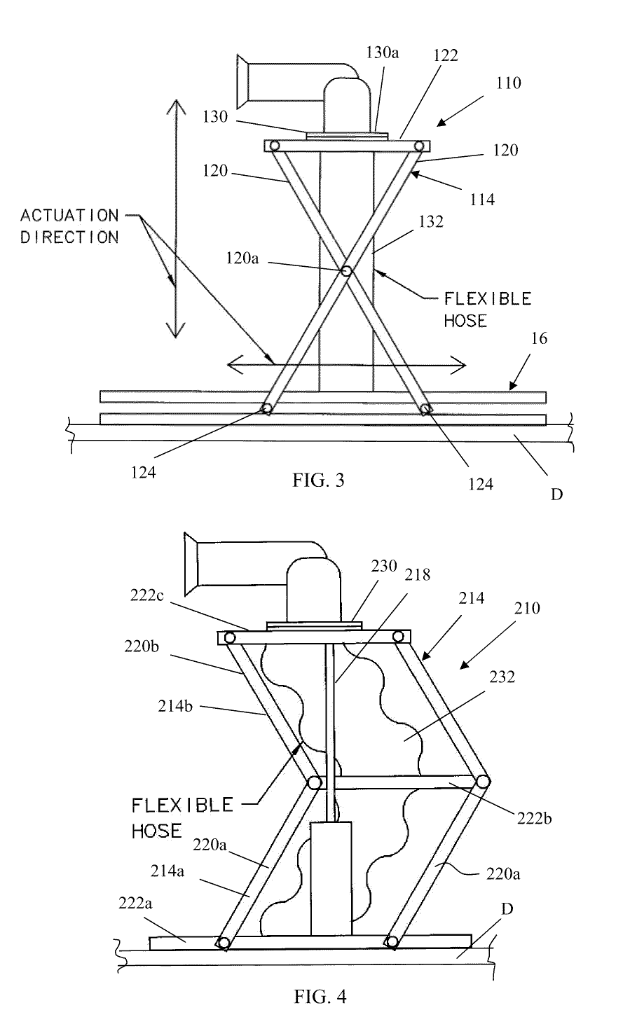

Referring to FIG. 3, another embodiment 110 of the support of the present invention is illustrated. Support 110 similarly comprises a collapsible frame that provides a mounting surface 130a in the form of a mounting flange 130 for mounting a monitor 12 to the support and is also used in combination with a flexible conduit 132. For further details of the conduit, monitor, and an actuator that may be used with frame 114, reference is made to the first embodiment.

In the illustrated embodiment, support 110 includes a frame 114 that is mounted to the deck D by a track or pair of tracks 116. Frame 114 is configured as a scissor-jack frame with four intersecting frame members 120 (just two shown), which are interconnected by a pivot connection 120a at, for example, their midpoints and support transverse plate 122 on which mounting flange 130 is provided, as described above. It should be understood that the alternate embodiments of the mounting surface described above may be used. Members 120 each include a guide member 124 for engaging track(s) 116 to allow the lateral translation of the proximal ends of the frame members 120 along tracks 116. Similarly, the distal ends of the respective frame members 120 include guides that engage similar tracks provided on transverse frame plate 122 so that the frame 114 can be collapsed to thereby lower or raise mounting flange 130 relative to the deck D of the fire truck.

Optionally, guide members 124 may be translated at a fixed spacing along track 116 to provide lateral movement of support 110 relative to the longitudinal axis of the fire truck.

As will be understood, frame 114 may be extended or collapsed using an actuator similar to actuator 18. Furthermore, the lateral position of the frame 114 along track 116 may also be similarly adjusted by a second actuator that moves the frame 114 along track 116.

Referring to FIG. 4, the numeral 210 designates another embodiment of the support of the present invention. Support 210 includes a stacked frame assembly 214 and a mounting surface 230 for supporting fire fighting monitor 12 on frame assembly 214. Similar to the previous embodiments, a flexible conduit 232 extends through frame assembly 214 for coupling the fire fighting monitor to a fluid supply. For further details of the various mounting surfaces that may be used reference is made to the first embodiment.

In the illustrated embodiment, frame assembly 214 includes an upper frame 214b and a lower frame 214a that are each similar to frame 14 but are interconnected to form a stack of collapsible frames, which collapse to provide a frame assembly that can collapse in the same or shorter deck space as frame 14 while providing the same or a higher reach, for example, than in the first embodiment. Lower frame 214a includes a plurality of column frame members 220a, which are interconnected by transverse plates 222a and 222b, with transverse plate 222a providing a connection to the deck D of the truck and upper transverse plate 222b providing connection to the upper frame 214b. Upper frame 214b similarly includes a plurality of column frame members 220b and an upper transverse plate 222c, with the proximal ends of column frame members 220b coupled to transverse plate 222b and pivotally coupled at their distal ends to transverse plate 222c to thereby form a frame assembly, which collapses about its intermediate transverse plates. As would be understood, therefore, each of the connections between the column frame members 220a and 220b and their respective transverse plates comprise pivot connections to allow the frame to collapse as shown in FIG. 4.

Optionally, support 210 also includes an actuator 218, which controls the collapse of frame assembly 214, by extension or contraction. Actuator 218 may comprise an electric hydraulic, pneumatic or manual actuator similar to the previous embodiments.

Consequently, in the present invention, the fire fighting monitor support decouples the waterway from the support structure so that the waterway may comprise a flexible conduit with the support being provided by a skeletal frame. This can reduce the friction loss due to joints and bends associated with existing waterways of current designs. As a result, the flexible conduit and the support of the present invention provide a fire fighting apparatus that can be assembled with fewer joints that require sealing and, as noted above, provide greater flexibility in its configuration and adaptability. Further, the present invention provides a wide variety of support configurations that are relatively simple to build and, further, reconfigure so that they may be adapted to fit many different applications.

While several forms of a skeletal collapsible frame have been shown and described, it should be understood that the invention is not limited to the specific form of the frame s depicted and described herein and, further, may be formed from multiple stacked frames to enhance the extension and reach of the monitor. Therefore, it will be understood that the embodiments shown in the drawings and described above are merely for illustrative purposes, and are not intended to limit the scope of the invention which is defined by the claims which follow as interpreted under the principles of patent law including the doctrine of equivalents.

The embodiments of the invention in which I claim an exclusive property right or: privilege are defined as follows:

1. A fire fighting device for a fire truck, the fire truck having a deck and a longitudinal axis, said fire fighting device comprising:
a frame, said frame adapted for mounting to the deck of the fire truck and having a mounting surface for mounting a fluid monitor to said frame; and
a flexible fluid conduit extending through said frame, said fluid conduit for fluid communication with a supply of fluid and for fluid communication with a fluid monitor mounted to said mounting surface for delivering fluid to the fluid monitor.

2. The fire fighting device according to claim 1, in combination with a fluid monitor, said fluid monitor being mounted to said mounting surface, and said fluid conduit in fluid communication with said fluid monitor.

3. The fire fighting device according to claim 1, wherein said mounting surface comprises a mounting flange.

4. The fire fighting device according to claim 1, wherein said flexible fluid conduit comprises a hose.

5. The fire fighting device according to claim 1, in combination with a fire truck, said fire truck having a deck, and said frame mounted to said deck.

6. The fire fighting device according to claim 1, wherein said frame comprises box-shaped frame with a plurality of frame members, each of said frame members having a frame connection for mounting to the deck of the fire truck.

7. The fire fighting device according to claim 1, wherein further comprising a guide track adapted to mount to the deck, said frame including a plurality guides for engaging said guide track.

8. The fire fighting device according to claim 7, wherein said guide track includes two guide tracks.

9. The fire fighting device according to claim 1, wherein said frame comprises a plurality of pivot connections for mounting said frame to the deck.

10. The fire fighting device according to claim 1, further comprising an actuator, said actuator for moving said mounting surface relative to the deck.

11. The fire fighting device according to claim 11, wherein said actuator comprises a linear actuator.

12. The fire fighting device according to claim 11, wherein said linear actuator comprises a cylinder.

13. The fire fighting device according to claim 1, wherein said frame is extendible for moving said mounting surface in an orthogonal direction to the longitudinal axis of the fire truck.

14. A fire fighting device for a fire truck, the fire truck having a deck and a longitudinal axis, said fire fighting device comprising:
a frame, said frame having a plurality of columns adapted for pivotally mounting to the deck of the fire truck and a plate, said columns pivotally mounted to said plate, said plate having a monitor mounting surface for mounting a fluid monitor to said frame; and
a flexible fluid conduit extending through said frame, said fluid conduit for fluid communication with a supply of fluid, and said plate having a conduit mounting surface for said flexible conduit wherein when said flexible conduit is mounted to said conduit mounting surface said conduit is in fluid communication with the fluid monitor mounted to said monitor mounting surface for delivering fluid to the fluid monitor.

15. The fire fighting device according to claim 14, in combination with a fluid monitor, said fluid monitor being mounted to said monitor mounting surface.

16. The fire fighting device according to claim 15, wherein said plate includes a first projecting cylindrical lip and a second projecting cylindrical lip, said first projecting cylindrical lip forming said monitor mounting surface, and said second projecting cylindrical lip forming said conduit mounting surface.

17. The fire fighting device according to claim 14, in combination with a fire truck, said fire truck having a deck, and said frame mounted to said deck.

18. A fire truck comprising:
a deck;
a collapsible frame mounting to said deck;
a fluid monitor supported by said frame; and
a flexible conduit extending through said frame and in fluid communication with said fluid monitor and a supply of fluid for delivering fluid to said fluid monitor.

19. The fire fighting device according to claim 18, wherein said flexible conduit comprises a hose.

20. The fire fighting monitor according to claim 18, wherein said frame includes a plurality of columns and a plate, said columns pivotally mounted at one end at said deck and pivotally mounted at an opposed end at said plate, said plate having a mounting surface for said monitor.

21. The fire fighting monitor according to claim 20, wherein said plate includes a monitor base, said monitor comprising a monitor body, said monitor base forming said mounting surface for mounting said monitor body to said plate.
